(19) United States
(12) Patent Application Publication
(10) Pub. No.: US 2007/0198248 A1
(43) Pub. Date: Aug. 23, 2007

(54) Voice recognition apparatus, voice recognition method, and voice recognition program

(75) Inventor: Shindoh Yasutaka, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/527,493

(22) Filed: Sep. 27, 2006

(30) Foreign Application Priority Data
Feb. 17, 2006 (JP) 2006-040208

(51) Int. Cl. G06F 17/27

(52) U.S. Cl. 704/9

(57) ABSTRACT

Keywords are extracted from input voice. A bit is set to each of objects as subjects, and a bit about affirmation/negation is set. The scope defined by combining bits for the respective objects is interpreted as a topic. Based on the bit about affirmation/negation, the input for the topic is interpreted.

### TECHNICAL FIELD

The present invention relates to voice recognition. In particular, the present invention relates to voice recognition using a dictionary of a relatively small scale for voice guidance or the like.

### BACKGROUND ART

In voice recognition, keywords are extracted from voice of a speaker, and the extracted keywords are combined to extract intention of the speaker. Japanese Laid-Open Patent Application Hei 5-204518 discloses a document processing apparatus. For a keyword “text”, three commands “text printing”, “text creation”, and “text editing” are available. A keyword “output” corresponds to the command “text printing”. Thus, when a phrase “I want to output the text” is inputted, the inputted phase is converted into the command “document printing”. In adopting the technique in a generalized manner, it is contemplated that a dictionary in which, for example, “text” and “document” can be regarded as synonymous terms, and rules for associating combination of the keywords extracted using the dictionary with meanings that are broader than those of the words are provided.

However, if the technique is adopted in a small voice recognition apparatus for interpreting the answer to the question by voice, screen, gestures or the like, sound recognition can be made in the following two stages.

(1) Creation of possible keywords for the questioning sentence.

(2) Creation of a dictionary and rules for interpreting the combination of keywords extracted using the dictionary.

If the dictionary and the rules for associating combination of the keywords extracted using the dictionary with meanings that are broader than those of the words are provided, creation of the dictionary or the like is a heavy task, and the process for carrying out the task is complicated.

For example, a system for providing guidance for the graduate course of a university, and providing guidance for the entrance examination information is envisaged. For a question “Which information do you need, the graduate course or the entrance examination outline?”, it is assumed that keywords “graduate course”, “entrance examination”, “both”, and “all” are provided beforehand. In this case, answers as intended by the designer of the system such as “Let me know about the graduate course.”, “I want to know both.” can be recognized easily. However, in the case of using the above keywords, in the case of “I don't want to know these items of information at all.”, since “all” is recognized, guidance for the graduate course and guidance for the entrance examination outline are provided mistakenly. Therefore, it is necessary to add keywords such as “don't want to know” or “don't need”. Further, for the input of “both of the graduate course and the entrance examination outline” a rule that permits to ignore the “graduate course” or the “the entrance examination outline” in the presence of “both” is added. Further, as in the case of “graduate course and the entrance examination outline, please”, if both of the “graduate course” and “examination outline” are detected, a rule defining that such detection is synonymous to “both” is added. In this manner, by adding the dictionary and rules, it is possible to recognize the input voice correctly. However, it is difficult to provide the dictionary and rules beforehand, and the process using the dictionary and rules becomes complicated. In particular, in the case of recognizing the answer to the question from a voice guidance apparatus or the like, since the dictionary and rules are generated for every questioning sentence, it is very difficult to provide a large dictionary or a large number of rules.

### SUMMARY OF THE INVENTION

An object of the present invention is to expand the range of recognizable expressions in input voice using simple rules and a small dictionary.

Another object of the present invention is to achieve the above object in a simple system.

Still another object of the present invention is to make it possible to carry out voice recognition even if input voice includes a plurality of keywords corresponding to the same subject.

Still another object of the present invention is to make it possible to interpret input voice even if a negative keyword is inputted without any subject.

According to the present invention, a voice recognition apparatus recognizes input voice by extracting keywords from the input voice. The voice recognition apparatus comprises: means for extracting the keywords from the input voice; subject extraction means for extracting a subject from a keyword about a topic in the extracted keywords; and negation detection means for detecting a keyword about negation from the extracted keywords. If the negation detection means does not detect any keyword about negation, the subject extracted by the subject extraction means is outputted as a recognition result, and if the negation detection means detects a keyword about negation, negation of at least the subject extracted by the subject extraction means is outputted as a recognition result.

Preferably, the voice recognition apparatus further comprises a memory at least storing data for each subject and data about negation. The subject extraction means sets data of subjects corresponding to the extracted keywords, and if the negation detection means detects the keyword about negation, the negation detection means sets the data about negation so as to recognize a meaning of the input voice based on the data for each subject and the data about negation.

In particular, preferably, if the subject extraction means extracts a subject corresponding to data already set, the subject extraction means keeps the data set. For example, each data comprises one bit data, and writing of the data is carried out by OR logic operation.

Further, preferably, the voice recognition apparatus recognizes the input voice as a response to the question mentioning the subjects in voice guidance, and when no data about subjects is set, and only the data about negation is set, the voice recognition apparatus recognizes all the subjects mentioned in the question are negated.

According to the present invention, a voice recognition method for recognizing voice by extracting keywords from input voice comprises the steps of: extracting the keywords from the input voice; processing a keyword about a topic from the extracted keywords to extract a subject about the topic; and detecting a keyword about negation from the extracted keywords. If no keyword about negation is detected, the extracted subject is outputted as a recognition result, and if a keyword about negation is detected, the negation of at least the subject is outputted as a recognition result.

According to the present invention, a voice recognition program for an apparatus for recognizing input voice by extracting keywords from the input voice, and the program comprises: an instruction for extracting the keywords from the input voice; a subject extraction instruction for processing a keyword about a topic from the extracted keywords to extract a subject about the topic; a negation detection instruction for detecting a keyword about negation from the extracted keywords; and an instruction for outputting, as a recognition result. If the negation detection instruction does not detect any keyword about negation, and negation of at least the subject, if the negation detection instruction detects a keyword about negation.

In the voice recognition apparatus, the voice recognition program, and the voice recognition program, if no keyword about negation is detected, a group of one or more subjects is outputted as a recognition result. If a keyword about negation is detected, it is determined that these subjects are negated. Thus, the interpretation rules for interpreting the meaning having the broader scope than these keywords, and the dictionary about the combination of the words are not necessary, or very simple. Regardless of whether the subjects are negated or not, it is possible to recognize the input voice correctly.

Data is assigned to each subject, and data is also assigned to affirmation/negation, and these items of data as a whole are determined as the result of voice recognition. In this case, by setting the corresponding data, it is possible to create data of the recognition result. The data can be interpreted uniquely as data listing the subjects as a topic, and indicating whether each subject is negated or affirmed. Further, at the time of creating the data, no complicated dictionary and rules are required.

For example, in the case where the input voice is “Please give me both of A and B.”, all of “A”, “B”, and “both” are keywords, and “both” indicate “A” and “B”, the input voice doubly includes the subjects “A” and “B”. Therefore, if a subject corresponding to data that has been set previously is detected again, by not changing the data, it is possible to interpret the input including the keywords having the same meaning. In the case where no data of subjects as a topic is set, and only the data about negation is set, if it is determined that all the subjects mentioned in a question are negated, it is possible to interpret negation in the input voice without any subject.

In the specification, unless specifically stated, the description about the voice recognition apparatus is directly applicable to the voice recognition method or the voice recognition program. Further, unless specifically stated, the description about the voice recognition method is directly applicable to the voice recognition apparatus or the voice recognition program.

### BRIEF DESCRIPTION OF THE DRAWINGS

FIG. 1 is a block diagram showing a voice recognition apparatus according to an embodiment and a voice guidance apparatus using the voice recognition apparatus.

FIG. 2 is a diagram showing a manner in which data is written in a register, and interpreted in the voice recognition apparatus according to the embodiment.

FIG. 3 is a table showing a specific example of a voice recognition process according to the embodiment.

FIG. 4 is a diagram showing the process of FIG. 3 in the form of a voice input process and a process in response to the voice input.

FIG. 5 is a flowchart showing a voice recognition method according to the embodiment.

FIG. 6 is a block diagram showing a voice recognition program according to the embodiment.

### BRIEF DESCRIPTION OF THE SYMBOLS

| | | | |
|---|---|---|---|
| 2 | voice guidance apparatus | 4 | microphone |
| 6 | amplifier | 8 | voice recognition apparatus |
| 10 | keyword extractor | 12 | dictionary |
| 14 | register | 16 | interpreter |
| 18 | processing system | 20 | scenario data memory |
| 22 | voice data generator | 24 | amplifier |
| 26 | speaker | 60 | voice recognition program |
| 61 | instructions for storing dictionaries | | |
| 62 | instructions for storing interpreting | | |
| | data | | |
| 63 | instructions for exchanging | | |
| | dictionary and interpreting data | | |
| 64 | instructions for keyword extraction | | |
| 65 | subject | | |
| 66 | affirmative/negative instructions | | |
| | for writing | | |
| 69 | instructions for interpreting | | |

### Embodiment

Hereinafter, an embodiment in the most preferred form for carrying out the present invention will be described.

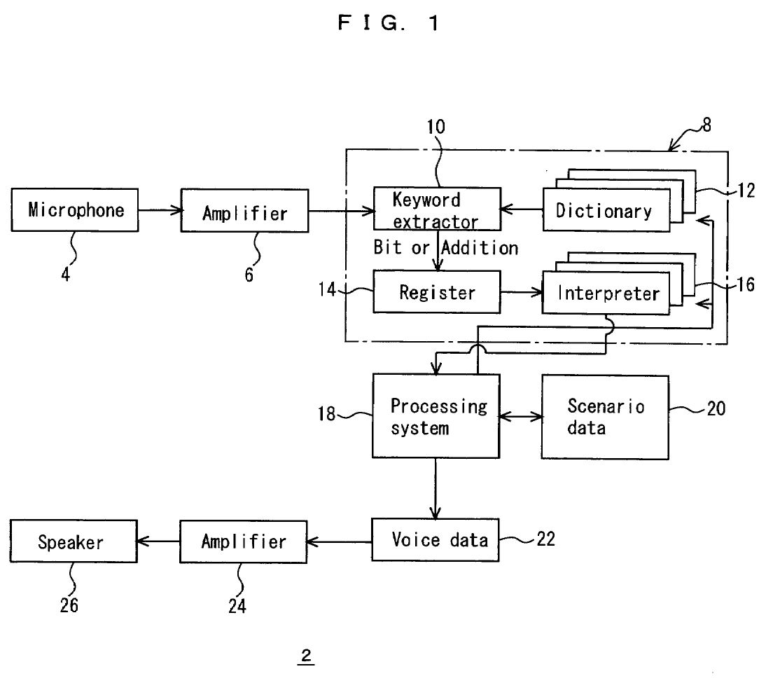

FIGS. 1 to 6 show a voice recognition apparatus 8, a voice recognition method, and a voice recognition program 60 according to the embodiment. In FIG. 1, a reference numeral 4 denotes a microphone, and a reference numeral 6 denotes an amplifier for the microphone 4. The amplifier 6 may not be provided. A reference numeral 8 denotes the voice recognition apparatus. The voice recognition apparatus 8 has a keyword extractor 10 for extracting keywords from voice inputted from the amplifier 6, and dictionaries 12 of extracted keywords. The dictionary 12 is modified each time a questioning sentence is created by a scenario data memory 20. For objects corresponding to the extracted keywords, bits of a register 14 are set. A reference numeral 16 denotes an interpreter for interpreting data of the register 14, and outputting a voice recognition result. It should be noted that interpretation of the data of the register 14 is easy. Therefore, the data of the register 14 may be recognized by a processing system 18.

In the specification, the “object” means an object extracted from the input voice. Synonymous terms “entrance examination outline” and “examination outline” correspond to the same object. The object includes a subject representing a topic in the input voice, and data regarding affirmation/negation. The processing system 18 refers to the voice recognition results, and provides voice guidance. The scenario data memory 20 stores output voices of questioning sentences or guidance sentences, and also stores scenarios for determining the next question or guidance based on the recognition result of the input voice in response to the questioning sentence. The dictionary 12 and the interpreter 16 are switched by the processing system 18 for each question sentence. A reference numeral 22 denotes a voice data generator, and a reference numeral 24 denotes an amplifier. The amplifier 24 may not be provided. A reference numeral 26 denotes a speaker.

The voice recognition apparatus 8 according to the embodiment is used for carrying out voice recognition by, e.g., a robot that provides guidance, or used for providing an automatic voice service using a telephone by, e.g., a telephone center or a support center. For example, the voice recognition apparatus 8 is used for providing balance statements by a bank. Further, the voice recognition apparatus 8 is used for various reservations and guidance. Further, the voice guidance apparatus 2 according to the embodiment is used for providing guidance using an office machine such as a facsimile machine or a complex machine having a copy function and a printer function. For example, the method of operating the office machine is provided for a user by voice guidance, and voice recognition of the question of the user is carried out for switching the content of the guidance. At the time of providing the questioning sentence or guidance for the user, in addition to voice, a screen or gestures of a robot may be used. In order to assist voice recognition, the user's facial expression or gestures may be recognized as an image.

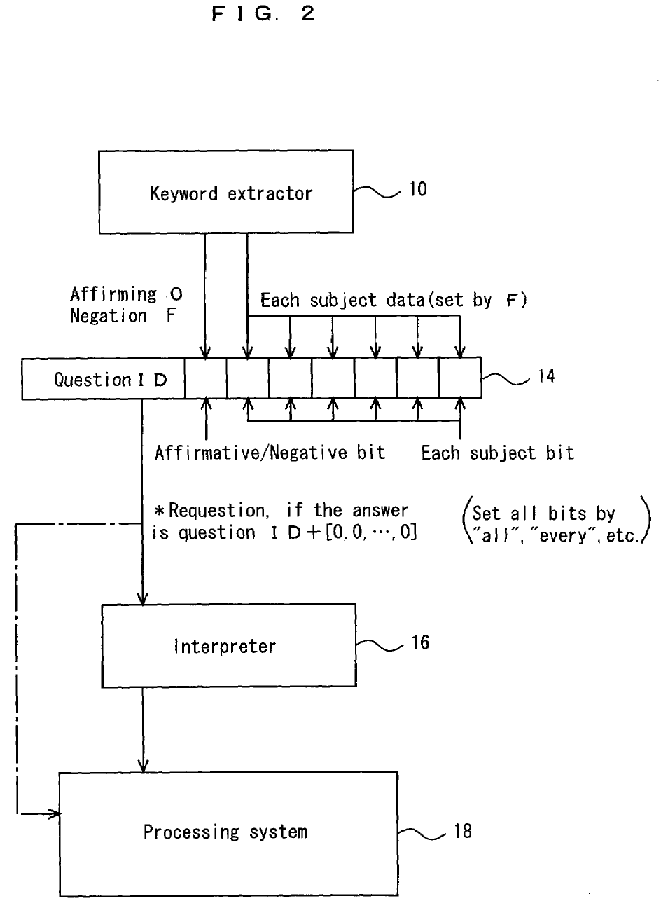

FIG. 2 shows processes carried out by the keyword extractor 10, the register 14, the interpreter 16, and the processing system 18. The register 14 stores IDs of questions, bits regarding affirmation/negation (affirmative/negative structure bits), and bits corresponding to respective subjects mentioned in the questioning sentence. Instead of assigning one bit to each of the subjects, a plurality of bits may be assigned to each of the subjects. The keyword extractor 10 extracts keywords from the input voice, and converts the keywords into data regarding affirmation or negation, or data for the respective subjects with reference to the dictionary 12. In the process, synonymous words correspond to the same object.

“0” in the register 14 indicates that the bit is not set, and “F” in the register 14 indicates that the bit is set. Based on the result of affirmation/negation extracted by the keyword extractor 10 and the subjects mentioned in the questioning sentence, the bits other than that of the question ID are set in the register 14. Since it is possible to omit data regarding affirmation, only data regarding negation may be extracted, and data regarding affirmation may not be extracted. A group of pieces of data for respective subjects correspond to the sum of subjects, i.e., the sum of sets. Data of negative bit represents that the respective elements in the subject set are negated. If no subject is identified, all the choices in the question are considered to be negated. The interpreter 16 carries out the above interpretation using data of the register 14, and inputs the voice recognition result to the processing system 18. As described above, the interpreter 16 may not be provided, and the data of the register 14 may be processed directly by the processing system 18. The register 14 is an example of storage. The form of storage or the form of data regarding the subject or the like can be determined arbitrarily.

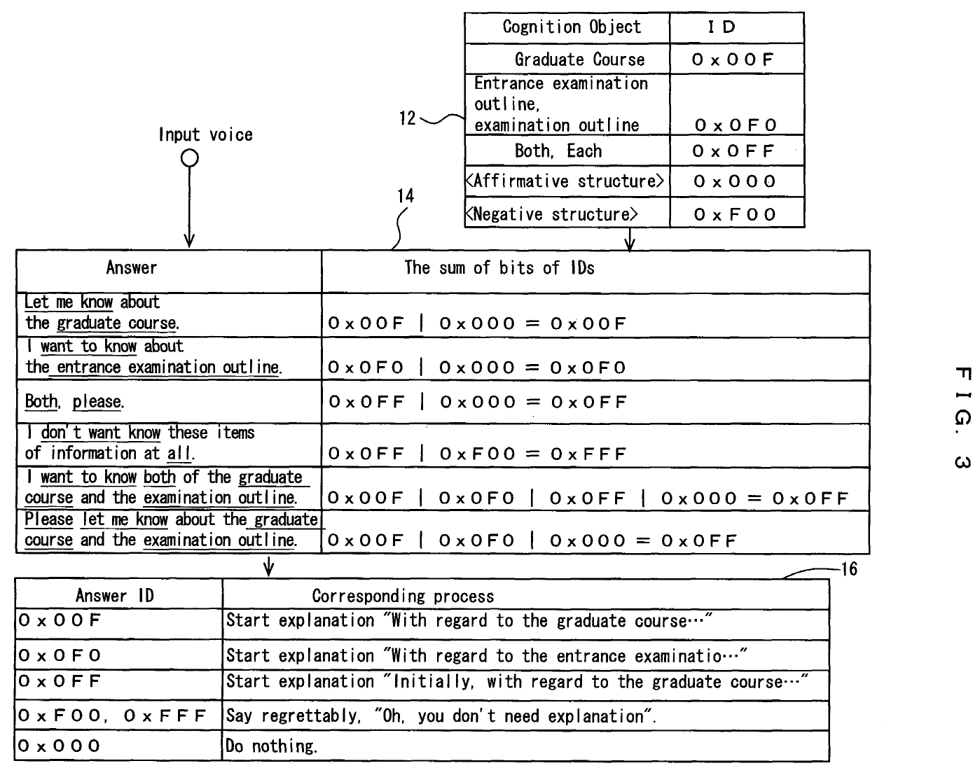

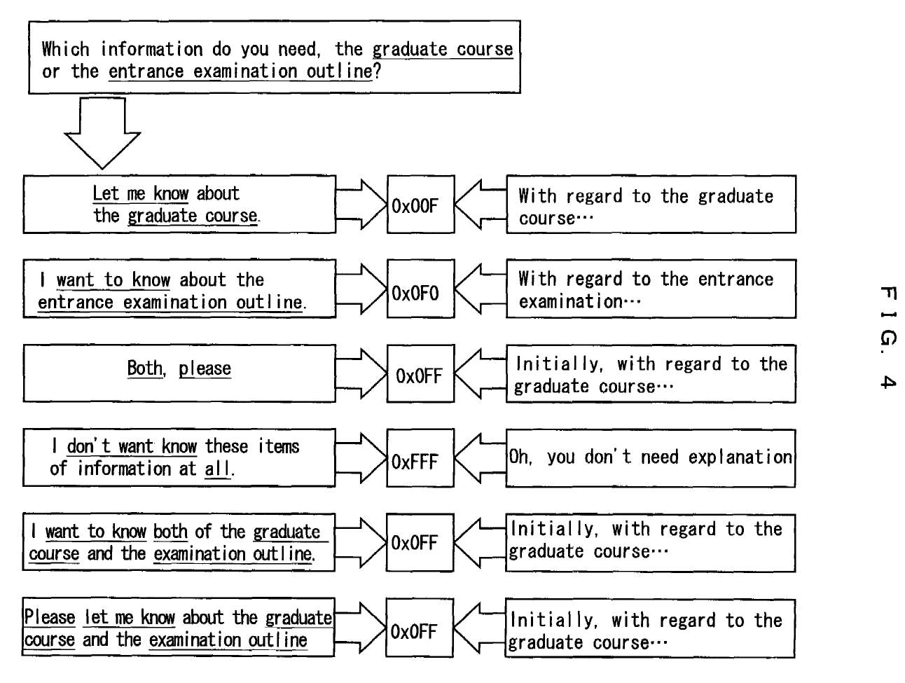

The processes of FIG. 2 are shown in detail in FIGS. 3 and 4, taking the case of providing guidance for the graduate course and entrance examination outline as an example. For example, it is assumed that as a questioning sentence, “Which information do you need, the graduate course or the entrance examination outline?” is used. In this case, as objects to be recognized for the questioning sentence, IDs are assigned to “graduate course” and “entrance examination outline” and its synonymous term “examination outline”, “both” and its synonymous term “all”, and affirmative structure and negative structure. The recognition result of the input voice in response to the question sentence can be represented by three low order bits data of the dictionary 12, and two high order bits can be omitted. Further, “both” and “all” can be expressed by the bit sum “0FF” for the “graduate course” and “entrance examination outline”. Further, the negative structure is considered as negation for the entire data of two low order bits representing the topic.

In the case where the input voice is “Let me know about the graduate course.”, from the keyword “graduate course”, “0x00F” is extracted. Since “Let me know” is affirmative structure, “0x000” is extracted. Based on the sum of bits of these items of data, “0x00F” is extracted. Thus, the process for providing guidance of “graduate course” is designated. In the case where the input voice is “I want to know about the entrance examination outline.”, from the keyword “entrance examination outline”, “0x0F0” is set, and since “I want to know” is affirmative structure, “0x000” is set. Based on the sum of bits of these items of data, “0x0F0” is set. In the case of “Both, please.”, “0x0FF” is set. In the case of “I don't want to know these items of information at all.”, since data corresponding to “all” is “0x0FF”, and data corresponding to “don't want to know” is “0xF00”, the sum of bits “0xFFF” is set. In the case where only the keyword indicating the subject is inputted without any affirmative structure or negative structure, e.g., in the case of “Graduate course.”, “0x00F” is set in the register 14. This input is regarded as the same as the input of “Graduate course, please.” or the like.

In the case of “I want to know both of the graduate course and the examination outline.”, for the keywords “graduate course” and “examination outline”, “0x00F” and “0 x0F0” are set. For the keyword “both”, “0x0FF” is set, and for the keyword “want to know”, “0x000” is set. As the sum of bits by OR addition, “0x0FF” is set. Though the keywords “graduate course” and “examination outline” and the keyword “both” have the same meaning, no problem occurs. In the case of “Please let me know about the graduate course and the examination outline.”, for the keywords “graduate course” and “examination outline”, “0x00F” and “0x0F0” are set, and for the keyword “please”, “0x000” is set. As the sum of bits of these items of data, “0x0FF” is set.

As a result, the three low order bits having the meaning in the data of the register 14 may have any of eight values in total. For example, in the case where the sum of bits is “0x00F”, the “graduate course” is explained. In the case where the sum of bits is “0x0F0”, both of the “graduate course” and “entrance examination outline” are explained. In these three cases, the highest order bit (most significant bit) 0 indicates an affirmative proposition, and is not used in interpretation. Further, the case of “0x000” is the same as the case where there is no topic for affirmation, and no data is inputted. Therefore, in this case, it is determined that there is no effective answer to the questioning sentence. Thus, for example, the question may be repeated again, or another question may be made. If the sum of bits of the answer is “0xF00” or “0xFFF”, it is determined that both of the “graduate course” and “entrance examination outline” are negated. In the case of “0xF0F” or “0xFF0”, it is determined that one of the “graduate course” and “entrance examination outline” is negated, and a guidance message for the other, i.e., “Would you like to have explanation about the entrance examination outline?” or “Would you like to have explanation about the graduate course?” is outputted. Otherwise, it is determined that only a negative answer is inputted as in the case of “0xF00”.

In the process of FIG. 3, “IDs are assigned to recognition objects such as the “graduate course” or affirmative structure, and the sum of bits of these items of data is determined by the register 14 to carry out voice recognition. In the process, as in the case of “I want to know both of the graduate course and the examination outline.”, even if the answer includes keywords having the same meaning, voice recognition can be carried out advantageously. Further, in the above description, all the bits, i.e., 5 bits or 3 bits are set for each object. Alternatively, only one bit of data may be written. For example, in the case of the “graduate course”, only the lowest order bit (least significant bit) is set, and in the case of the “entrance examination outline”, the bit next to the least significant bit is set.

FIG. 4 shows the input voice to the questioning sentence and the recognition result as the process shown in FIG. 3. At least one bit is assigned to each of the subjects in the questioning sentence. For data regarding affirmation/negation such as “please” or “I don't want to know”, one bit is assigned. For the keywords having a broad scope in meaning such as “both” or “all”, the bits of subjects included in the scope are set. In the case of the input such as “I don't want to know these items of information at all”, without providing any meaning for the “all”, simply, two low order bits are set for “all”, and one high order bit is set for “I don't want to know”. In the case of the input sentence “I want to know both of the graduate course and the examination outline.” containing different keywords having the same meaning, the sum of bits for the corresponding subjects is determined. By the simple process, it is possible to carry out voice recognition without any contradiction.

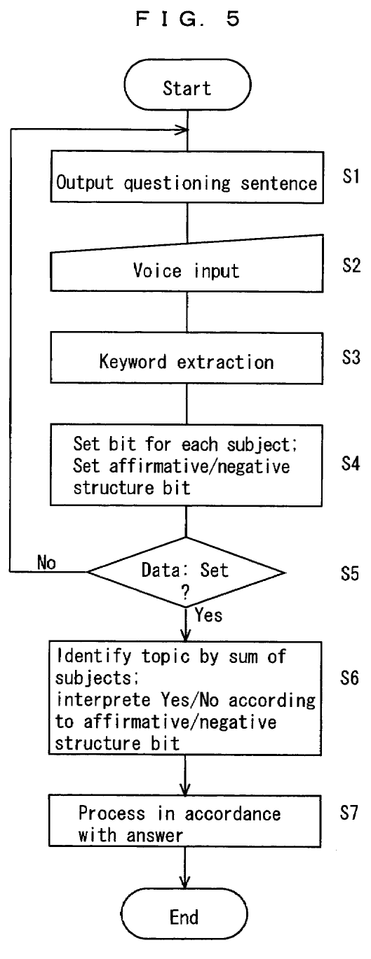

FIG. 5 shows a voice recognition method according to the embodiment. The explanations about FIGS. 1 to 4 are directly applicable to the voice recognition method shown in FIG. 5. In step 1, a questioning sentence is outputted. In step 2, voice input is received. In step 3, keywords are extracted. After conversion of synonymous terms or the like in the extracted keywords, the bit is set for each subject. The affirmative/negative structure or simple negative/affirmative words such as “Yes”, “No” are searched, and a bit indicating affirmation/negation is set (step 4). After the input voice is processed, in step 5, it is checked whether data is set or not, i.e., whether any data having a meaning is present or not in the register. If no data is present, the questioning sentence is outputted again. If data is set, the topic is identified by the sum of subjects, and interpretation as to whether the sum of subjects has been negated or affirmed is made based on the affirmative/negative structure bit (step 6). If only the negative structure bit is set without any topic, it is interpreted that all of choices have been negated, or the questioning sentence is totally negated. Then, a process in accordance with the answer is carried out in step 7.

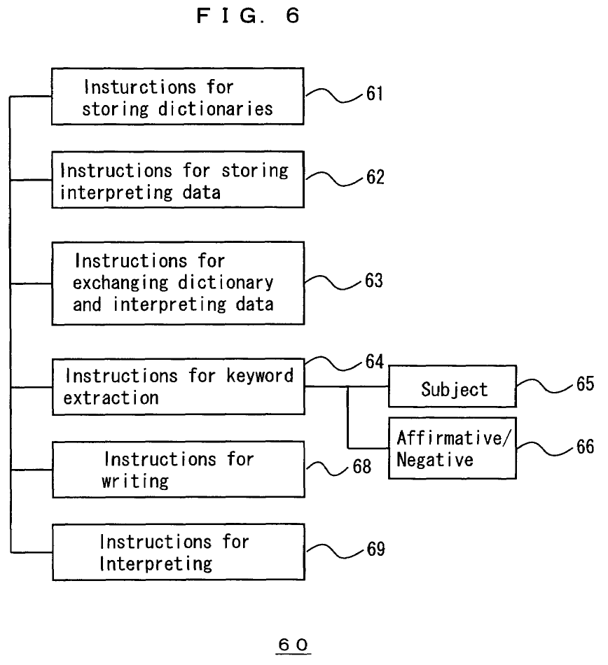

FIG. 6 shows structure of the voice recognition program according to the embodiment. The program is installed in a suitable personal computer or the like to constitute the voice recognition apparatus 8 in FIG. 1. Instructions 61 store dictionaries for respective questions, and instructions 62 store interpreting data in the register 14 in FIG. 1. The instructions 62 may not be provided. In the case where the dictionaries 12 and the interpreter 16 in FIG. 1 are provided, instructions 63 change the dictionary and interpreting data for each questioning sentence. Instructions 64 extract keywords from the input voice. For the extracted keywords, instructions 65 identify the corresponding subject, and instructions 66 further extract affirmative/negative keywords. Instructions 68 write data extracted by the instructions 65 or the instructions 66 in the register 14 in FIG. 1. Instructions 69 interpret data of the register 14 in FIG. 1 using the interpreting data provided for each of the questions. The instructions 69 may not be provided.

1. A voice recognition apparatus for recognizing input voice by extracting keywords from the input voice, the apparatus comprising:
means for extracting the keywords from the input voice;
subject extraction means for extracting a subject from a keyword about a topic in the extracted keywords; and
negation detection means for detecting a keyword about negation from the extracted keywords, wherein
if the negation detection means does not detect any keyword about negation, the subject extracted by the subject extraction means is outputted as a recognition result, and if the negation detection means detects a keyword about negation, negation of at least the subject extracted by the subject extraction means is outputted as a recognition result.

2. The voice recognition apparatus according 1, further comprising a memory at least storing data for each subject and data about negation, wherein
the subject extraction means sets data of subjects corresponding to the extracted keywords, and if the negation detection means detects the keyword about negation, the negation detection means sets the data about negation so as to recognize a meaning of the input voice based on the data for each subject and the data about negation.

3. The voice recognition apparatus according to claim 2, wherein if the subject extraction means extracts a subject corresponding to data already set, the subject extraction means keeps the data set.

4. The voice recognition apparatus according to claim 2, wherein the voice recognition apparatus recognizes the input voice as a response to the question mentioning the subjects in voice guidance, and when no data about subjects is set, and only the data about negation is set, the voice recognition apparatus recognizes all the subjects mentioned in the question are negated.

5. A voice recognition method for recognizing voice by extracting keywords from input voice, comprising the steps of:
extracting the keywords from the input voice;
processing a keyword about a topic from the extracted keywords to extract a subject about the topic; and
detecting a keyword about negation from the extracted keywords, wherein
if no keyword about negation is detected, the extracted subject is outputted as a recognition result, and if a keyword about negation is detected, the negation of at least the subject is outputted as a recognition result.

6. A voice recognition program for an apparatus for recognizing input voice by extracting keywords from the input voice, the program comprising:
an instruction for extracting the keywords from the input voice;
a subject extraction instruction for processing a keyword about a topic from the extracted keywords to extract a subject about the topic;
a negation detection instruction for detecting a keyword about negation from the extracted keywords; and
an instruction for outputting, as a recognition result, the extracted subject,
if the negation detection instruction does not detect any keyword about negation, and negation of at least the subject, if the negation detection instruction detects a keyword about negation.
